(19) United States
(12) Patent Application Publication
(10) Pub. No.: US 2012/0187658 A1
(43) Pub. Date: Jul. 26, 2012

(54) vehicle trailer hitch platform system

(75) Inventors: Jason Wheeler, Panhandle, TX (US); Terry Wheeler, Panhandle, TX (US)

(73) Assignee: WHEELER FOGGER, LLC, Amarillo, TX (US)

(21) Appl. No.: 13/356,644

(22) Filed: Jan. 23, 2012

Related U.S. Application Data
(63) Continuation-in-part of application No. 13/017,014, filed on Jan. 30, 2011.
Application No. 13/017,014 is a continuation-in-part of application No. 13/011,833, filed on Jan. 21, 2011.

(51) Int. Cl. B62D 63/08; B60R 9/06; B62D 63/06

(52) U.S. Cl. 280/415.1; 280/400; 280/490.1

(57) ABSTRACT

A vehicle trailer hitch platform system is disclosed. In one embodiment, said vehicle trailer hitch platform system comprises a platform assembly. Said platform assembly comprises a platform, a undercarriage, a hitch connector, and one or more leg assemblies. Said platform is capable of receiving a load. Said undercarriage is capable of supporting said platform assembly. Said hitch connector capable of attaching to a trailer hitch of a vehicle. Said one or more leg assemblies are capable of supporting platform assembly. Said platform assembly comprises a first side, a second side, a front, a back, a top and a bottom. Said undercarriage comprises said hitch connector. Said leg assemblies selectively attach to platform assembly.

### BACKGROUND

This disclosure relates generally to a vehicle trailer hitch platform system. In one embodiment, this disclosure relates to said vehicle trailer hitch platform system wherein said system carries a wheelchair, an ATV and a Jet Ski. However, these embodiments are exemplary and useful for illustrating a portion of the uses of said system.

Prior filings by the Applicants discuss the background of said vehicle trailer hitch platform system and are also herein incorporated by reference. Namely, U.S. patent application Ser. Nos. 13/017,014 and 13/011,833.

Prior vehicle trailer hitch platform systems leave much to be desired. Although trailers are capable of carrying a load, they require substantial effort to connect and pull behind a vehicle. Also, when a trailer is pulled on a wheel assembly, there arise hazardous driving conditions due to the effect of pulling a separate vehicle (a trailer) in tow. Likewise, loading and uploading prior trailers is difficult and in need of updating as is herein accomplished.

None of the above inventions and patents, taken either singularly or in combination, is seen to describe the instant disclosure as claimed. Accordingly, an improved vehicle trailer hitch platform system would be advantageous.

### SUMMARY

A vehicle trailer hitch platform system is disclosed. In one embodiment, said vehicle trailer hitch platform system comprises a platform assembly. Said platform assembly comprises a platform, a undercarriage, a hitch connector, and one or more leg assemblies. Said platform is capable of receiving a load. Said undercarriage is capable of supporting said platform assembly. Said hitch connector capable of attaching to a trailer hitch of a vehicle. Said one or more leg assemblies are capable of supporting platform assembly. Said platform assembly comprises a first side, a second side, a front, a back, a top and a bottom. Said undercarriage comprises said hitch connector. Said leg assemblies selectively attach to platform assembly.

### BRIEF DESCRIPTION OF THE DRAWINGS

FIGS. 1A, 1B, 1C and 1D illustrate an elevated top view, bottom view, front view and side view of a platform assembly.

FIGS. 2A and 2B illustrate a lower perspective of platform assembly and a detailed lower perspective view of one of leg assemblies.

FIG. 2C illustrates a perspective overview of platform assembly with leg assemblies detached.

FIGS. 3A, 3B and 3C illustrate a perspective overview of platform assembly 100 with leg assemblies 106 in said open position and extended configuration, said open position and compressed configuration, and said closed position and compressed configuration, respectively.

FIGS. 4A, 4B and 4C illustrate a perspective overview and detailed view of platform assembly aligned with vehicle and a perspective detailed view of attached to vehicle.

FIGS. 5A, 5B, 5C and 5D illustrate a plurality elevated side views of platform assembly attached to vehicle where leg assemblies are in said open position, said compressed configuration, said closed position, and removed, respectively.

FIG. 6 illustrates a perspective overview of platform assembly attached to vehicle with a wheelchair on hitch connector.

FIG. 7 illustrates a perspective overview of an expanding platform assembly.

FIG. 8 illustrates expanding platform assembly in a wide configuration.

FIG. 9 illustrates expanding platform assembly aligning with trailer hitch.

FIG. 10 illustrates ATV on expanding platform assembly and expanding platform assembly attached to vehicle.

FIG. 11 illustrates a perspective overview of ATV on expanding platform assembly, expanding platform assembly attached to vehicle, and leg assemblies removed from expanding platform assembly.

FIG. 12 illustrates a perspective overview of an alternate platform assembly.

FIG. 13 illustrates alternate platform assembly aligned with trailer hitch.

FIG. 14 illustrates alternate platform assembly attached to vehicle.

FIG. 15 illustrates a perspective overview of Jet Ski loaded on alternate platform assembly, and alternate platform assembly attached to vehicle.

FIG. 16 illustrates a perspective overview of Jet Ski loaded onto alternate platform assembly and leg assemblies removed from alternate platform assembly.

### DETAILED DESCRIPTION

Described herein is a 000. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

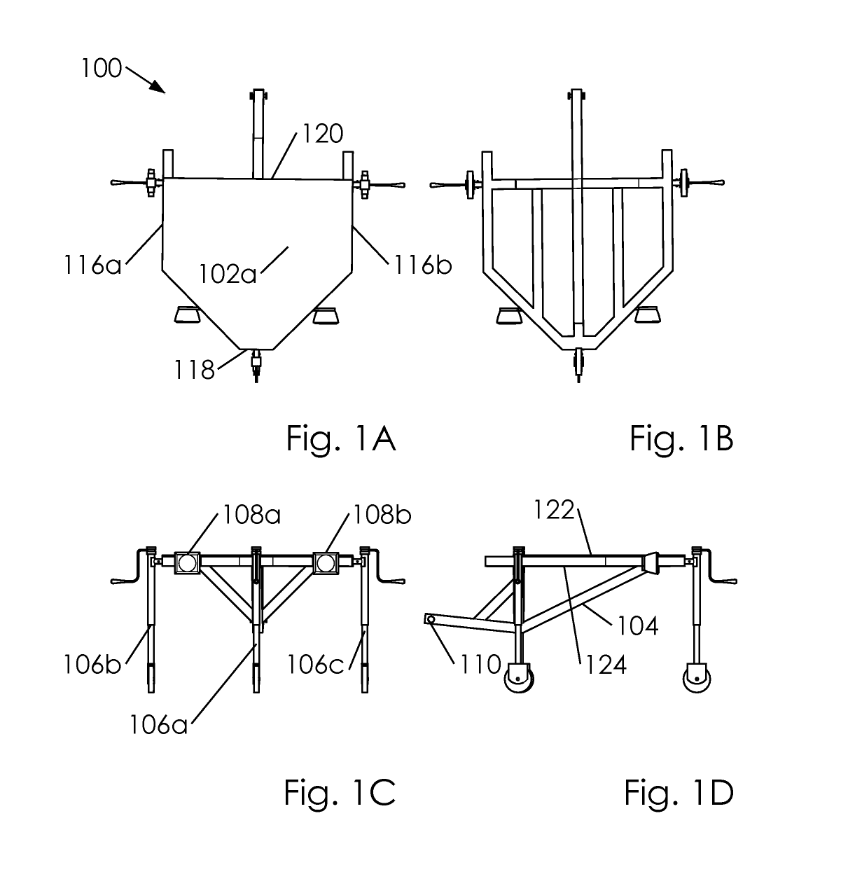

FIGS. 1A, 1B, 1C and 1D illustrate an elevated top view, bottom view, front view and side view of a platform assembly 100. In one embodiment, platform assembly 100 can comprise a platform 102, an undercarriage 104, one or more leg assemblies 106, one or more taillight assemblies 108, and a hitch connector 110. In one embodiment, platform assembly 100 can attach to a vehicle 112 (not illustrated here). In one embodiment, platform assembly 100 attaches to vehicle 112 with hitch connector 110. In one embodiment, platform assembly 100 can carry a load 114 (not illustrated here). In one embodiment, platform 102 can comprise a substantially flat surface capable of receiving a variety of types of loads 114; wherein load 114 are capable of being set on platform assembly 100. Leg assemblies 106 can comprise a first leg assembly 106a, a second leg assembly 106b and a third leg assembly 106c. In one embodiment, leg assemblies 106 can each comprise a means of supporting platform assembly 100. In one embodiment, said leg assemblies 106 can comprise three or more legs capable of stabilizing platform assembly 100. In one embodiment, taillight assemblies 108 can comprise a first taillight assembly 108a and a second taillight assembly 108b. In one embodiment, taillight assemblies 108 can be incorporated into a breaking and signaling system of vehicle 112.

In one embodiment, platform assembly 100 can comprise a first side 116a, a second side 116b, a front 118, a back 120, a top 122, and a bottom 124. In one embodiment, first leg assembly 106a can attach to front 118. In one embodiment, second leg assembly 106b can attach to first side 116a. In one embodiment, third leg assembly 106c can attach to second side 116b.

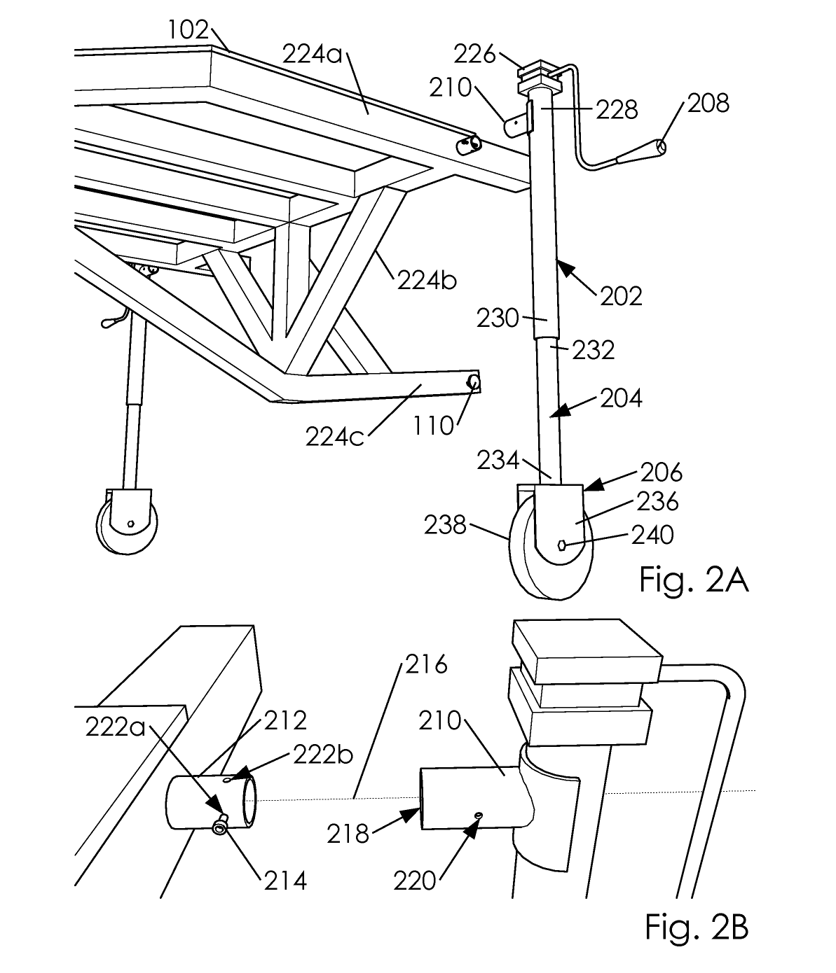

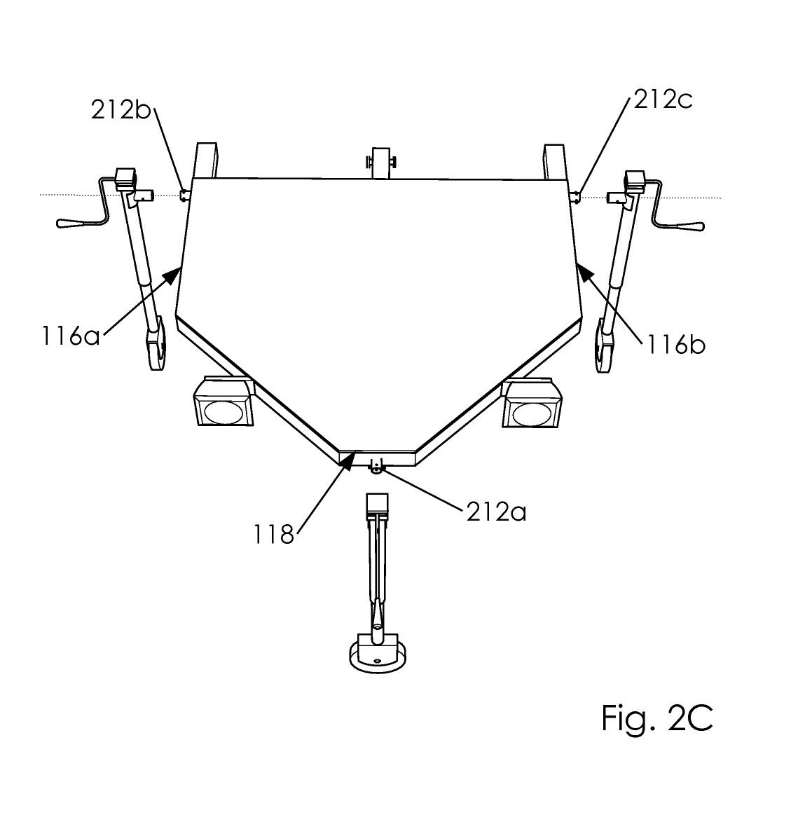

FIGS. 2A and 2B illustrate a lower perspective of platform assembly 100 and a detailed lower perspective view of one of leg assemblies 106. In one embodiment,

Each of leg assemblies 106 can comprise a first segment 202, a second segment 204, a leg wheel assembly 206, a crank 208, a socket 210, a socket base 212, and a pin 214. In one embodiment, second segment 204 can telescope from within first segment 202 as crank 208 is turned.

In one embodiment, leg assemblies 106 can attach to platform assembly 100 by aligning socket 210 with socket base 212 about an axis 216 and sliding said socket 210 around socket base 212. In one embodiment, socket 210 and socket base 212 are substantially round. In one embodiment, socket 210 comprises an opening 218 capable of receiving a portion of socket base 212. In one embodiment, socket 210 can rotate about socket base 212 around said axis 216. In one embodiment, each of leg assemblies 106 can be removed from platform assembly 100 by pulling said pin 214 and lifting said leg assemblies 106 out and away from platform assembly 100.

In one embodiment, pin 214 can slide through apertures 220 in socket 210 and/or one or more apertures 222 in socket base 212. In one embodiment, apertures 220 can comprise pairs of holes in socket 210. In one embodiment, apertures 213 can comprise pairs of holes in socket base 212. In one embodiment, apertures 222 can comprise a first set 222a and a second set 222b of apertures 222; wherein first set 222a and second set 222b are substantially perpendicular to one another about axis 216. In one embodiment, pin 214 can hold said socket 210 on socket base 212 by sliding pin 214 through apertures 220 and one or more of apertures 222. In one embodiment, pin 214 can hold leg assemblies 106 in one or more rotary positions, such as an open position and a closed position. In one embodiment, said open position can comprise leg assemblies 106 substantially perpendicular to platform 102. In one embodiment, where said leg assemblies 106 are in said open position, leg assemblies 106 can support platform assembly 100. In one embodiment, said closed position can comprise said leg assemblies 106 substantially parallel to platform 102. In one embodiment, where leg assemblies 106 are in said closed position, platform assembly 100 must be supported by something other than leg assemblies 106, such as hitch connector 110 attached to vehicle 112, as discussed infra. In one embodiment, pin 214 can slide through apertures 220 and first set 222a to hold leg assemblies 106 in said open position. In one embodiment, pin 214 can slide through apertures 220 and second set 222b to hold leg assemblies 106 in said closed position.

In one embodiment, undercarriage 104 can comprise a plurality of supports 224 designed to distribute weight from load 114 and platform assembly 100 to leg assemblies 106 or hitch connector 110. In one embodiment, supports 224 can comprise square tubing. In one embodiment, each among supports 224 can be welded together to create undercarriage 104. In one embodiment, supports 224 can comprise one or more first supports 224a, one or more second supports 224b, and one or more third supports 224c. In one embodiment, said first supports 224a can attach to and support said platform 102. In one embodiment, second supports 224b can attach to and support said first support 224a. In one embodiment, third supports 224c can attach to and support said second supports 224b. In one embodiment, third supports 224c can comprise hitch connector 110.

In one embodiment, each of leg assemblies 106 can be assembled from first segment 202, second segment 204, leg wheel assembly 206, crank 208, socket 210 and/or a top portion 226. In one embodiment, leg assemblies 106 can be described from top to bottom as comprising top portion 226, first segment 202, second segment 204 and leg wheel assembly 206, with crank 208 attached to a side portion of top portion 226 and socket 210 attached to a side portion of first segment 202. In one embodiment, first segment 202 can comprise a first end 228 and a second end 230. In one embodiment, second segment 204 can comprise a first end 232 and a second end 234. In one embodiment, leg wheel assembly 206 can comprise an outer portion 236, a wheel 238 and an axle 240. In one embodiment, top portion 226 can attach to first end 228. In one embodiment, first end 232 can slide into an opening at second end 230. In one embodiment, second end 234 can attach to outer portion 236. In one embodiment, outer portion 236 can wrap around a portion of wheel 238. In one embodiment, wheel 238 can spin around axle 240. In one embodiment, axle 240 can attach to a portion of outer portion 236.

FIG. 2C illustrates a perspective overview of platform assembly 100 with leg assemblies 106 detached. In one embodiment, platform assembly 100 can comprise a plurality of said socket base 212 each corresponding to said leg assemblies 106. In one embodiment, socket base 212 can comprise a first socket base 212a, a second socket base 212b, and a third socket base 212c. In one embodiment, first socket base 212a can attach at front 118 of platform assembly 100. In one embodiment, second socket base 212b can attach at first side 116a and third socket base 212c can attach at second side 116b. In one embodiment, socket base 212 can be welded to a portion of undercarriage 104 and/or platform 102.

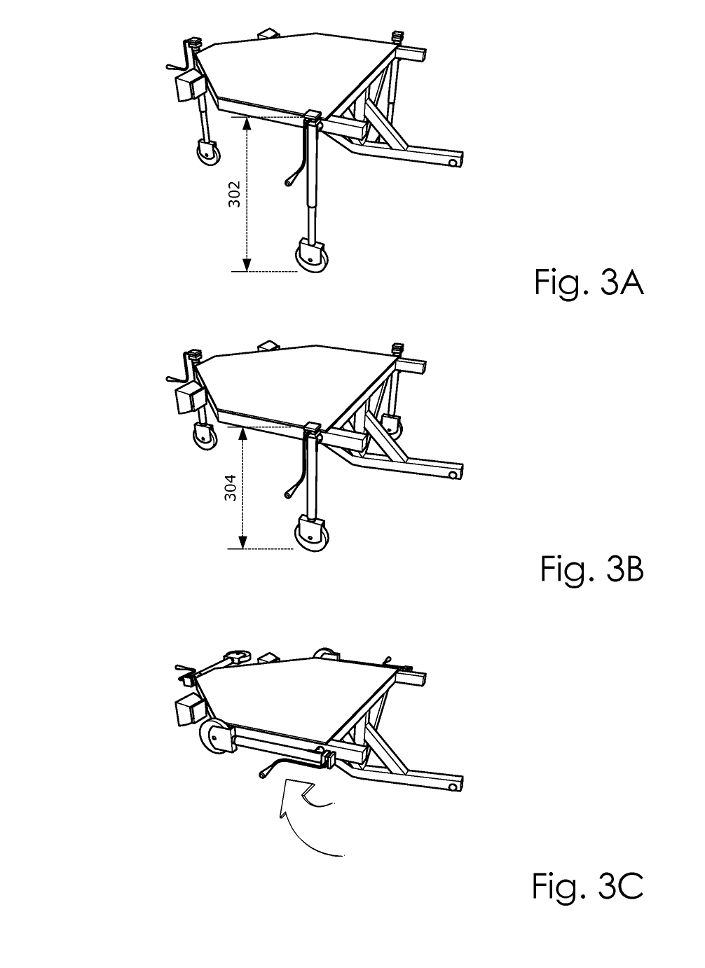

FIGS. 3A, 3B and 3C illustrate a perspective overview of platform assembly 100 with leg assemblies 106 in said open position and extended configuration, said open position and compressed configuration, and said closed position and compressed configuration, respectively. In one embodiment, leg assemblies 106 can comprise said extended configuration and said compressed configuration. In one embodiment, a length 300 of leg assemblies 106 can be selectively changed between an extended length 302 and a compressed length 304. In one embodiment, said extended configuration comprises leg assemblies 106 in extended length 302. In one embodiment, said compressed configuration comprises leg assemblies 106 in compressed length 304. In one embodiment, each of leg assemblies 106 can comprise a jack capable of extending and contracting by turning crank 208. For example, in one embodiment, selectively changing said length 300 between extended length 302 and compressed length 304 can comprise rotating said crank 208 and, thereby causing second segment 204 to telescope in and out of first segment 202. In one embodiment, crank 208 can be internally attached to a screw thread to apply a high linear force.

In one embodiment, storing leg assemblies 106 can comprise compressing leg assemblies 106 into compressed length 304 and rotating leg assemblies 106 from said open position to said closed position, as illustrated in FIGS. 3A-3C.

In one embodiment, socket base 212 and socket 210 can rotate through a range of movement and comprise a start and a stop defined by one or more angle iron stops. In one embodiment, said range of movement can be a rotary movement around axis 216.

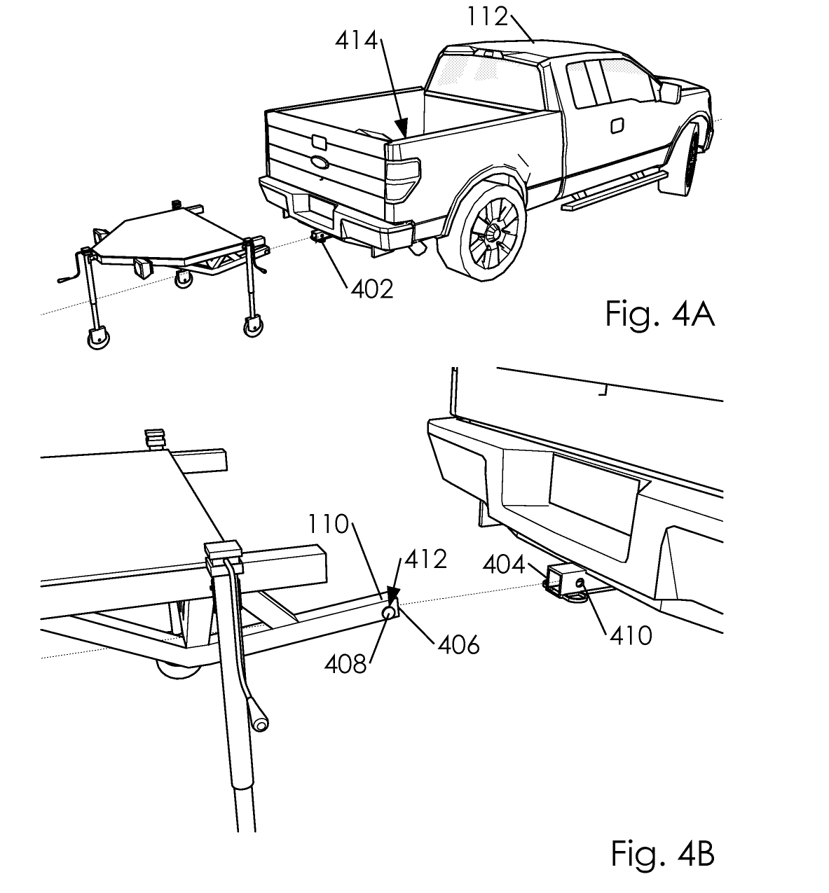

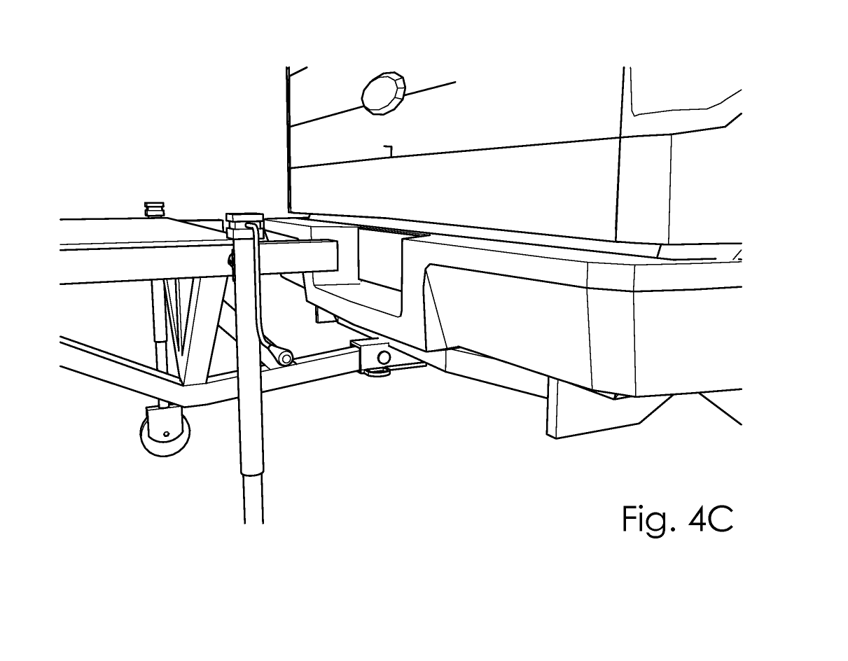

FIGS. 4A, 4B and 4C illustrate a perspective overview and detailed view of platform assembly 100 aligned with vehicle 112 and a perspective detailed view of platform assembly 100 attached to vehicle 112. Vehicle 112 can comprise a trailer hitch 402. In one embodiment, trailer hitch 402 can comprise an opening 404 capable of receiving a portion of hitch connector 110. In one embodiment, aligning hitch connector 110 with trailer hitch 402 can comprise aligning an end portion 406 of hitch connector 110 with opening 404. In one embodiment, hitch connector 110 can comprise a pin 408. In one embodiment, trailer hitch 402 can comprise one or more apertures 410 capable of receiving pin 408. In one embodiment, hitch connector 110 can comprise one or more apertures 412 capable of receiving pin 408. In one embodiment, an external circumference of hitch connector 110 can slide within an internal circumference of trailer hitch 402. In one embodiment, attaching platform assembly 100 to vehicle 112 can comprise attaching hitch connector 110 to trailer hitch 402. In one embodiment, attaching hitch connector 110 to trailer hitch 402 can comprise removing pin 408 from hitch connector 110, aligning hitch connector 110 with opening 404, inserting end portion 406 into opening 404, aligning apertures 410 with apertures 412, and inserting pin 408 through apertures 410 and apertures 412.

In one embodiment, aligning hitch connector 110 with trailer hitch 402 can comprise moving platform assembly 100 behind vehicle 112, and extending and/or compressing end portion 406 to align hitch connector 110 vertically with trailer hitch 402. Thus, in one embodiment, leg assemblies 106 can be used to align hitch connector 110 with trailer hitch 402. Accordingly, platform assembly 100 is capable of simplifying common configuration tasks.

In one embodiment, trailer hitch 402 can comprise a portion that can mount to the frame of vehicle 112 that has a rearward facing opening that accepts ball mounts, cargo carriers, or other hitch mounted accessories. Vehicle 112 can comprise a truck (as illustrated in FIGS. 4A-C); wherein, trailer hitch 402 can comprise a tow-ball capable of allowing swiveling and articulation of a trailer, or a tow pin and jaw with a trailer loop.

In another embodiment, platform assembly 100 can be carried in a bed 414 of vehicle 112, bypassing the need for hitch connector 110.

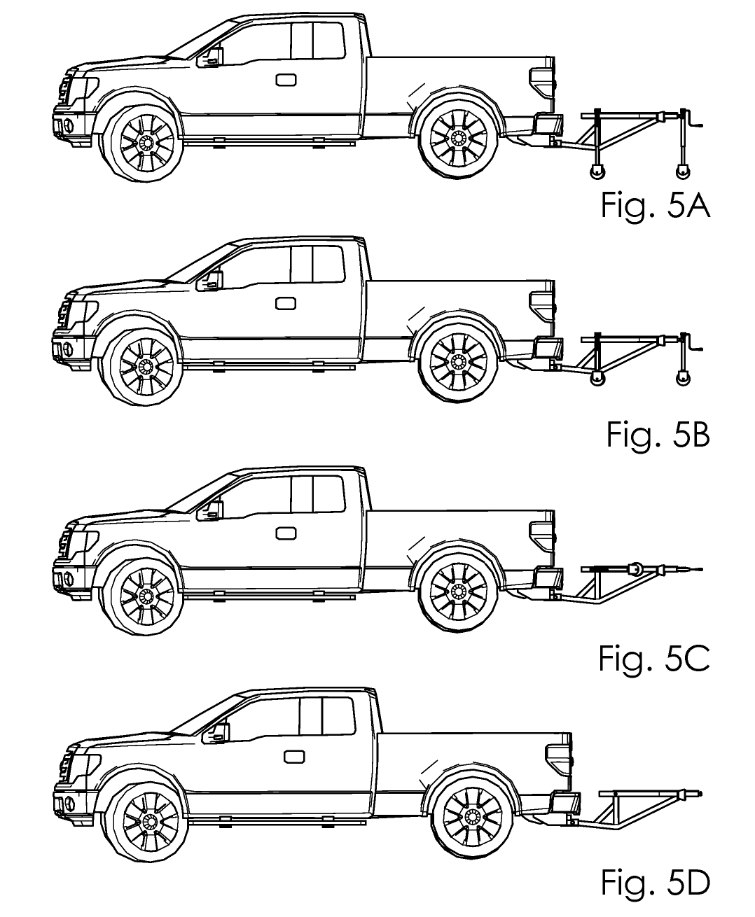

FIGS. 5A, 5B, 5C and 5D illustrate a plurality elevated side views of platform assembly 100 attached to vehicle 112 where leg assemblies 106 are in said open position, said compressed configuration, said closed position, and removed, respectively.

Once platform assembly 100 is attached to vehicle 112, leg assemblies 106 can be reconfigured so as to not interfere with the movement of vehicle 112. For example, in one embodiment, leg assemblies 106 can be rotated and locked into closed position. In another embodiment, leg assemblies 106 can be removed from platform assembly 100 to eliminate interference with the movement of vehicle 112.

In one embodiment, vehicle 112 can comprise a tractor. In one embodiment, platform assembly 100 may be attached to and operate behind said tractor. Said tractor can comprise three-point hitch. In one embodiment, platform assembly 100 can be attached to said tractor with a three-point adapter. A discussion of said tractor, said three-point hitch and said three-point adapter has been disclosed by the applicants in US Patent Application number [To Come] and is hereby incorporated by reference.

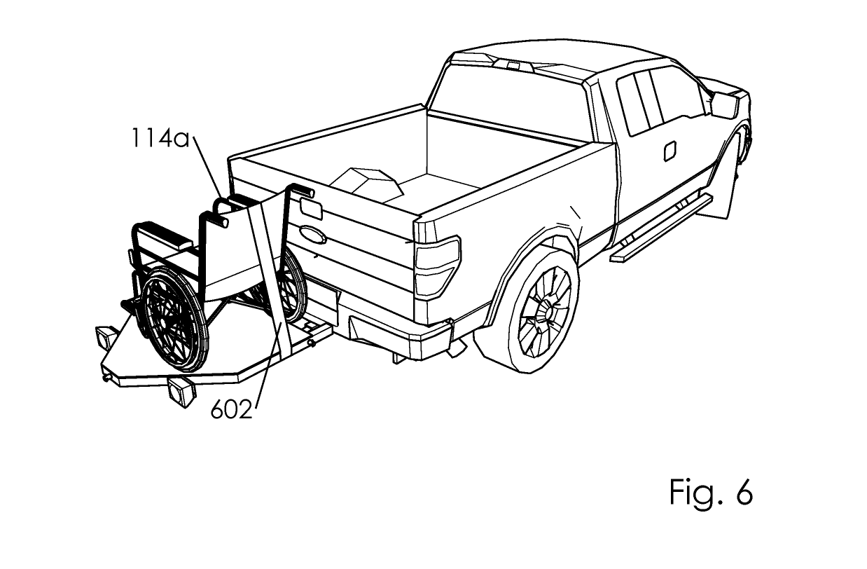

FIG. 6 illustrates a perspective overview of platform assembly 100 attached to vehicle 112 with a wheelchair 114a on hitch connector 110. Load 114 can comprise said wheelchair 114a. In one embodiment, load 114 can comprise a barbeque pit, an industrial device, or other item needing to be transported on platform assembly 100. In one embodiment, wheelchair 114a can be held on platform assembly 100 with a strap 602.

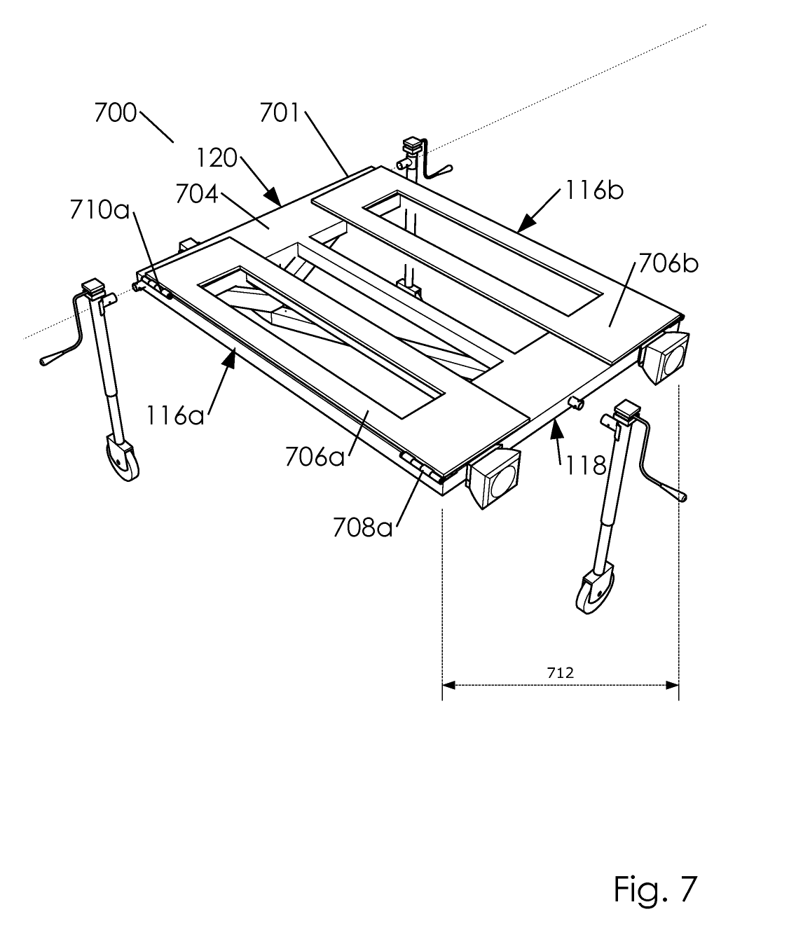

FIG. 7 illustrates a perspective overview of an expanding platform assembly 700. In one embodiment, platform assembly 100 may need to be modified to comprise features of expanding platform assembly 700 where load 114 has special requirements. For example, in one embodiment, load 114 can comprise an ATV 702 (illustrated infra) and platform assembly 100 may not comprise sufficient width to haul ATV 702.

Expanding platform assembly 700 can comprise a platform 701 having a central portion 704 and one or more wing portions 706. Expanding platform assembly 700 can comprise first side 116a, second side 116b, front 118 and back 120. In one embodiment, each of wing portions 706 can rotate on one or more hinges, such as a first hinge 708 and a second hinge 710. In one embodiment, expanding platform assembly 700 can comprise one or more of said leg assemblies 106 each capable of attaching to said socket base 212, as discussed with platform assembly 100. In one embodiment, expanding platform assembly 700 can comprise a narrow configuration 712. In one embodiment, narrow configuration 712 can comprise wing portions 706 rotated on first hinge 708 and second hinge 710 to cause wing portions 706 to rest on central portion 704 and thereby minimize a width of 701.

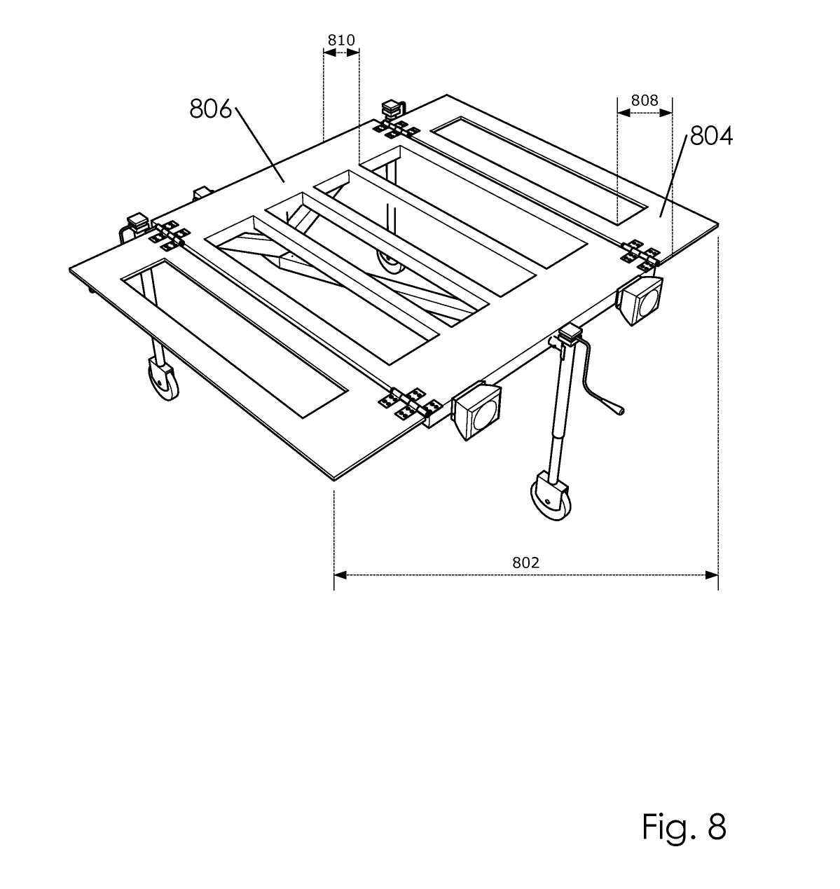

FIG. 8 illustrates expanding platform assembly 700 in a wide configuration 802. Platform 701 can comprise narrow configuration 712 and wide configuration 802. In one embodiment, wide configuration 802 can comprise wing portions 706 rotated to be substantially parallel with central portion 704 and to substantially maximize said width of platform 701. In one embodiment, platform 701 can comprise a wheel track 804 and a wheel track 806. Wheel track 804 can comprise a width 808. Wheel track 806 can comprise a width 810. In one embodiment, width 808 and width 810 are each wide enough to accommodate a wheel 812 (not illustrated here) of ATV 702 (also not illustrated here).

In one embodiment, wing portions 706 can each rotate approximately 180 degrees on first hinge 708 and second hinge 710 between narrow configuration 712 and wide configuration 802.

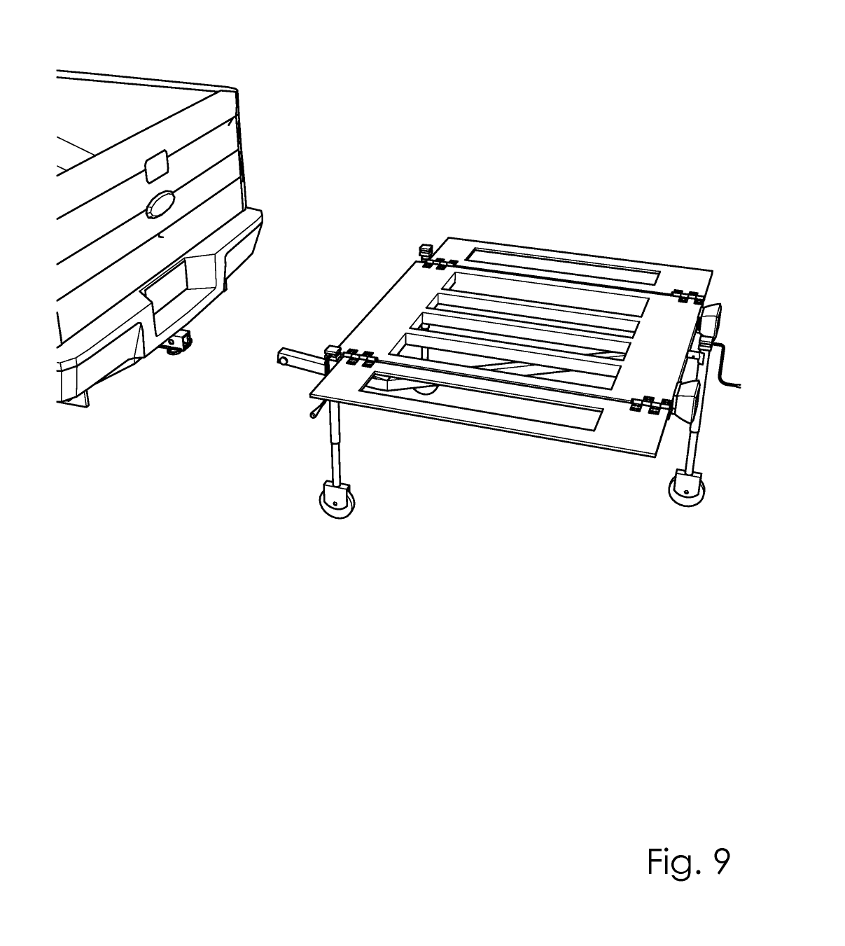

FIG. 9 illustrates expanding platform assembly 700 aligning with trailer hitch 402. In one embodiment, expanding platform assembly 700 can attach to vehicle 112 in substantially the same manner as platform assembly 100 attaches to vehicle 112.

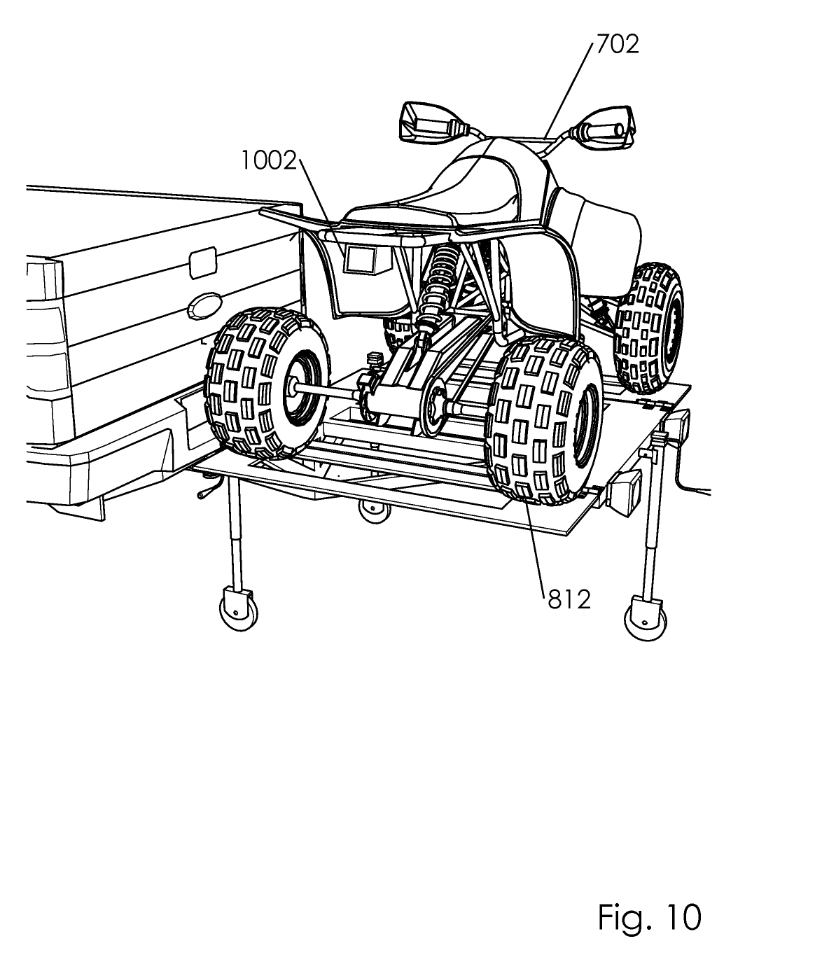

FIG. 10 illustrates ATV 702 on expanding platform assembly 700 and expanding platform assembly 700 attached to vehicle 112. ATV 702 can comprise a plurality of wheels 812. In one embodiment, “ATV” can comprise an all-terrain vehicle, a Mule®, a four wheeler, a three wheeler, or similar. In one embodiment, ATV 702 can comprise a trailer hitch 1002. In one embodiment, trailer hitch 1002 can be similar to trailer hitch 402.

In one embodiment, expanding platform assembly 700 can be attached to ATV 702. In one embodiment, ATV 702 can ride on expanding platform assembly 700, be removed from expanding platform assembly 700, and then attach expanding platform assembly 700 to trailer hitch 1002.

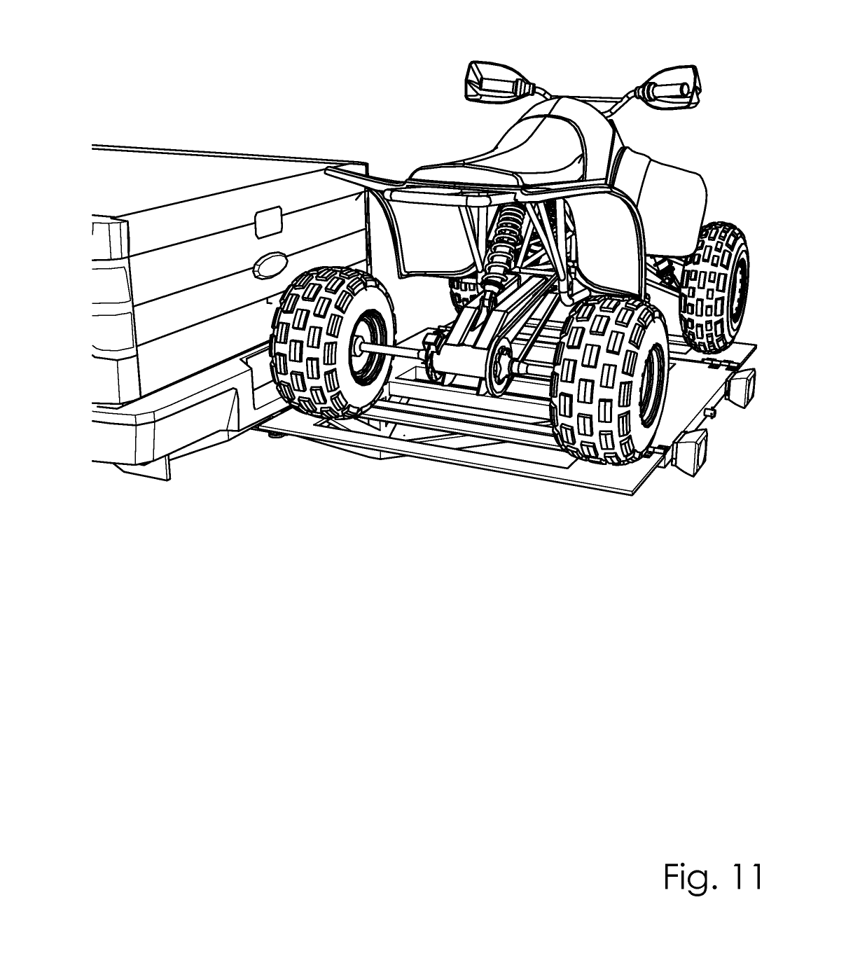

FIG. 11 illustrates a perspective overview of ATV 702 on expanding platform assembly 700, expanding platform assembly 700 attached to vehicle 112, and leg assemblies 106 removed from expanding platform assembly 700. As with platform assembly 100, leg assemblies 106 can be adjusted and removed from expanding platform assembly 700.

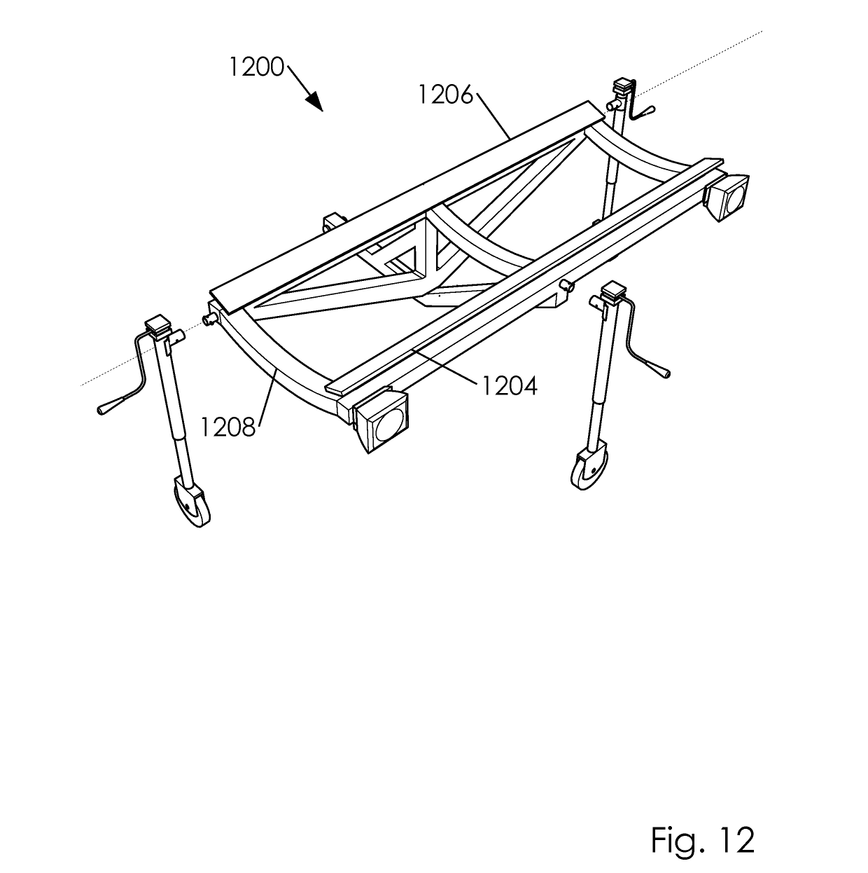

FIG. 12 illustrates a perspective overview of an alternate platform assembly 1200. In one embodiment, platform assembly 100 may need to be modified to comprise features of vehicle 112 where load 114 has further special requirements. For example, in one embodiment, load 114 can comprise a Jet Ski 1202 (illustrated infra) and platform assembly 100 may otherwise cause damage to Jet Ski 1202. In one embodiment, Jet Ski 1202 can comprise a trademarked name for a jet-propelled personal watercraft, or a personal watercraft of any kind.

Alternate platform assembly 1200 can comprise a first side brace 1204 and a second side brace 1206. In one embodiment, In one embodiment, alternate platform assembly 1200 can comprise plurality of arched supports 1208 under first side brace 1204 and second side brace 1206. In one embodiment, alternate platform assembly 1200 can comprise a plurality of leg assemblies 106 capable attaching to a plurality of socket bases 212, as discussed supra for platform assembly 100.

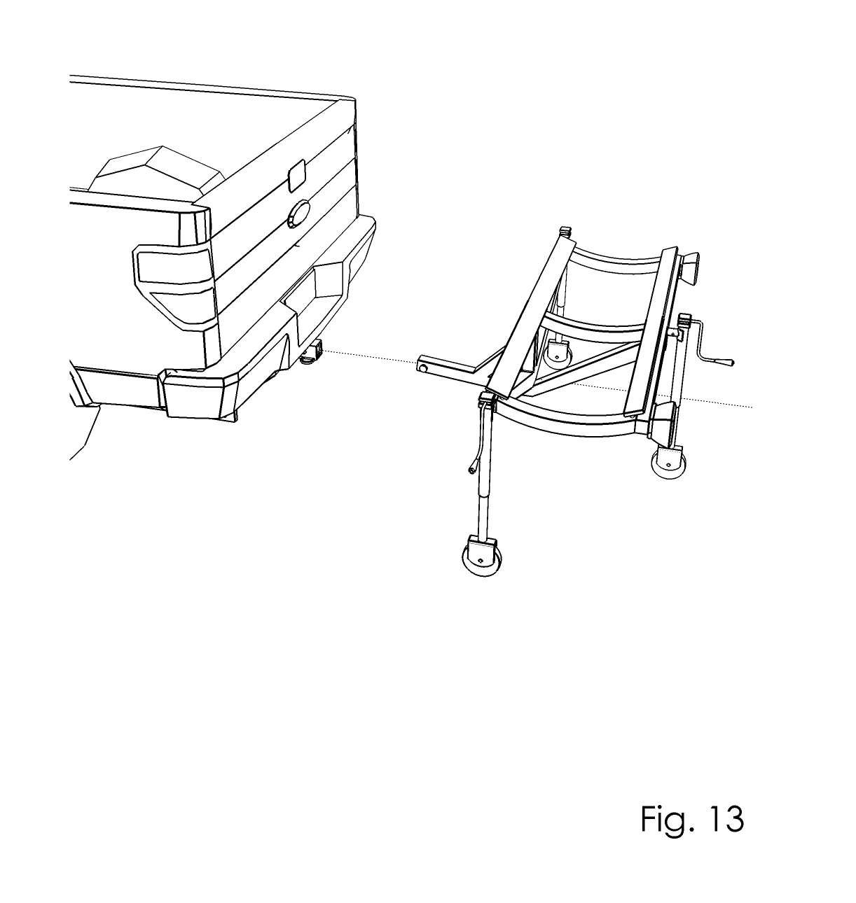

FIG. 13 illustrates alternate platform assembly 1200 aligned with trailer hitch 402. Alternate platform assembly 1200 can attach to vehicle 112 in a similar manner as platform assembly 100.

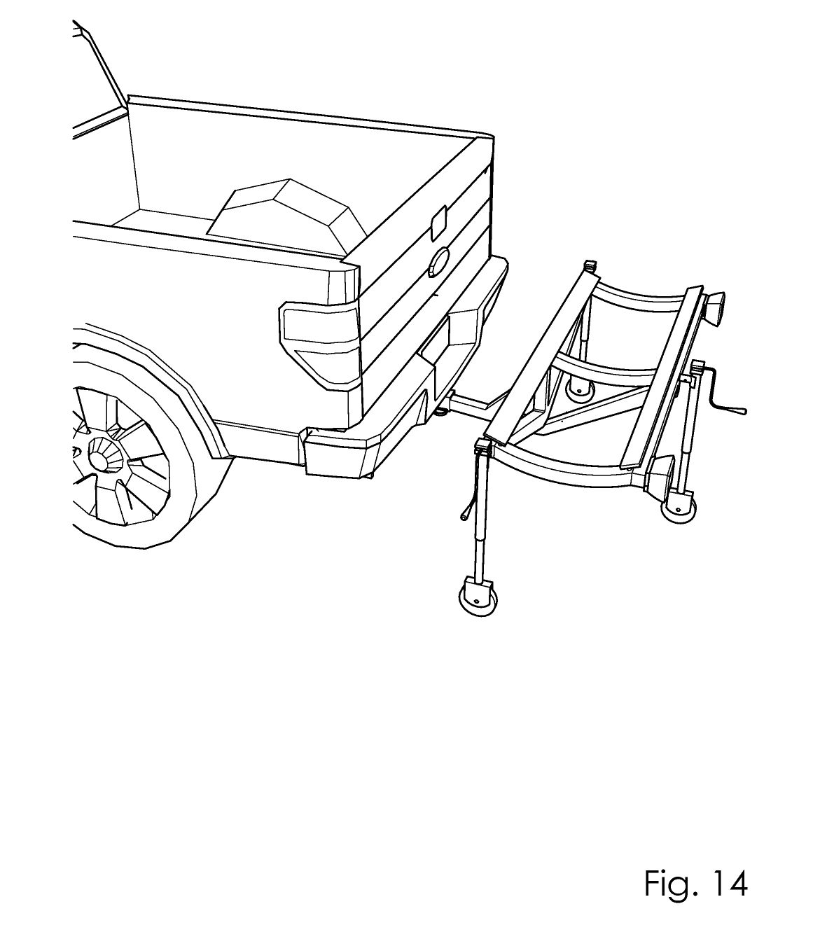

FIG. 14 illustrates alternate platform assembly 1200 attached to vehicle 112.

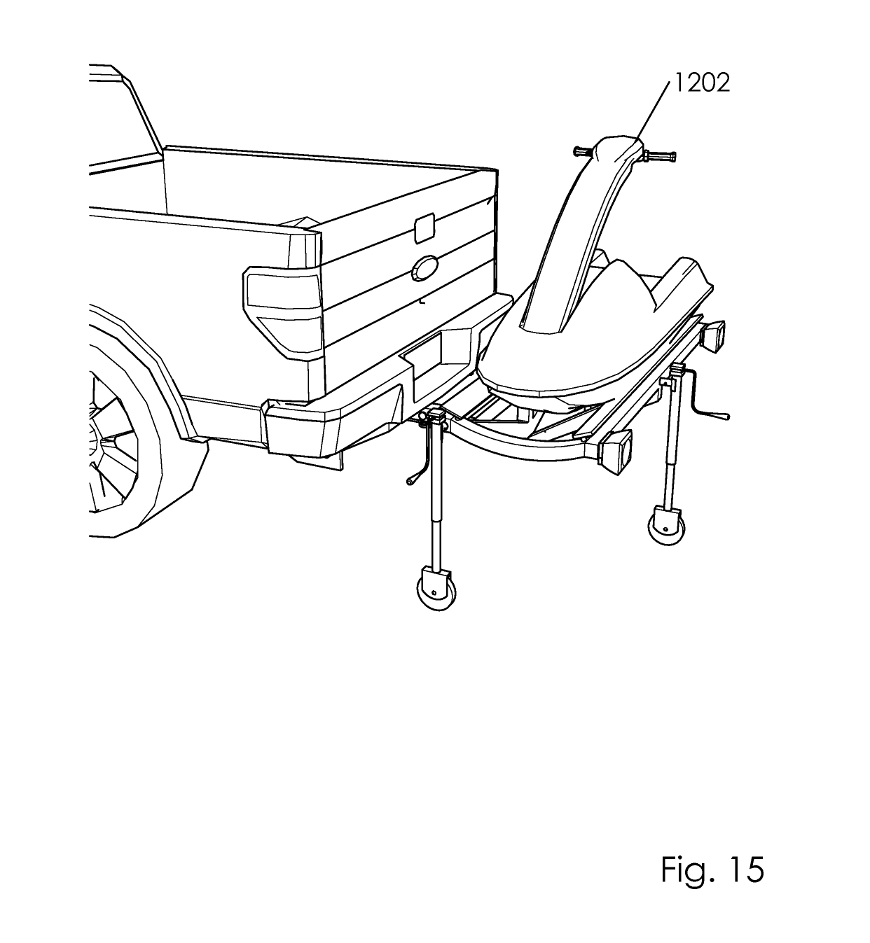

FIG. 15 illustrates a perspective overview of Jet Ski 1202 loaded on alternate platform assembly 1200, and alternate platform assembly 1200 attached to vehicle 112. In one embodiment, first side brace 1204 and second side brace 1206 can support Jet Ski 1202 along opposing lower side edges of Jet Ski 1202 as is common with boat trailers and Jet Ski trailers known in the art. In one embodiment, Jet Ski 1202 can be arranged perpendicular to vehicle 112 when placed on vehicle 112. In one embodiment, loading and unloading Jet Ski 1202 from alternate platform assembly 1200 in a body of water can comprise backing 112 partially into said body of water, aligning Jet Ski 1202 between first side brace 1204 and second side brace 1206, sliding Jet Ski 1202 between and onto first side brace 1204 and second side brace 1206 and/or sliding Jet Ski 1202 off of first side brace 1204 and second side brace 1206.

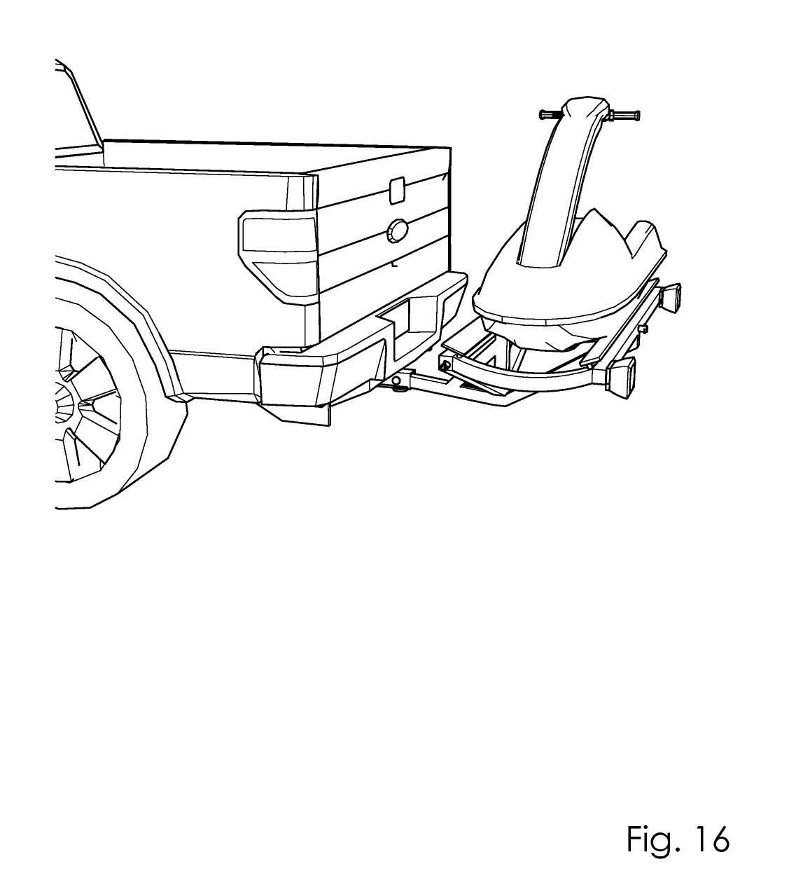

FIG. 16 illustrates a perspective overview of Jet Ski 1202 loaded onto alternate platform assembly 1200 and leg assemblies 106 removed from alternate platform assembly 1200.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A platform assembly comprising:
a platform capable of receiving a load,
a undercarriage capable of supporting said platform assembly,
a hitch connector capable of attaching to a trailer hitch of a vehicle, and
one or more leg assemblies capable of supporting platform assembly; wherein,
said platform assembly comprises a first side, a second side, a front, a back, a top and a bottom;
said undercarriage comprises said hitch connector; and,
said leg assemblies selectively attach to platform assembly.

2. Said platform assembly of claim 1 further comprising a strap; wherein:
said load comprises a wheelchair;
said platform is substantially flat;
said wheelchair can sit on top of said platform; and
said strap can hold said wheelchair on top of said platform assembly.

3. Said platform assembly of claim 1 wherein:
said load comprises a barbeque grill and
said barbeque grill can rest on said platform assembly.

4. Said platform assembly of claim 1 wherein:
said load comprises an ATV,
said platform comprises a width capable of holding said ATV.

5. Said platform assembly of claim 4 wherein:
said platform comprises one or more wing portions;
said wing portions are capable of rotating upon one or more hinges;
said width of said platform can expand between a narrow configuration and a wide configuration by
folding said wing portions out to expand said platform to said wide configuration and
folding said wing portions in to contract said platform to said narrow configuration.

6. Said platform assembly of claim 4 wherein:
said platform comprises two wheel tracks each having a width capable of accommodating a wheel of said ATV; and
said wheel tracks are parallel to one another.

7. Said platform assembly of claim 4 wherein:
said platform can support said ATV,
and said platform assembly can attach to a trailer hitch on said ATV after
said ATV is unloaded from said platform assembly and
said platform assembly is detached from said vehicle.

8. Said platform assembly of claim 1 wherein:
said load comprises a personal watercraft,
said platform comprises a first side brace and a second side brace,
said first side brace and said second side brace are parallel to one another and capable of supporting two opposing bottom portions of said personal watercraft.

9. Said platform assembly of claim 1 wherein
said one or more leg assemblies comprise a socket and
said platform assembly comprises one or more socket bases capable of receiving said sockets of said leg assemblies.

10. Said platform assembly of claim 9 wherein said leg assemblies can attach to said platform assembly by:
aligning said sockets and said socket base,
inserting said socket bases into said socket, and
securing said socket bases to said sockets.

11. Said platform assembly of claim 1 wherein
said leg assemblies comprise a height and
said height can be adjusted.

12. The platform assembly of claim 11 wherein:
said leg assemblies further comprise a first segment, a second segment, and a crank;
said crank is attached to a screw thread jack inside of said legs; and
said crank rotates in two rotary directions capable of adjusting a relative height of said base, wherein
rotating said crank in a first rotary direction extends said second segment of said legs from within said first segment of said legs, and
rotating said crank in a second rotary direction detracts said second segment of said legs back into said first segment of said legs.

13. The platform assembly of claim 1 wherein
said platform assembly is capable attaching to said vehicle and being used while said vehicle is in motion without a trailer by
attaching said base to said vehicle with trailer hitch and said hitch connector,
supporting said platform assembly on said hitch connector, and
holding said platform assembly off the ground.
